(19) United States
(12) Patent Application Publication
(10) Pub. No.: US 2025/0361741 A1
(43) Pub. Date: Nov. 27, 2025

(54) Building System Capable of Withstanding Strong Winds, Earthquakes, Flooding, and Other Natural Disasters

(71) Applicant: Genuine Global Products LLC, Miami, FL (US)

(72) Inventor: Marvin George, Miami, FL (US)

(21) Appl. No.: 19/275,705

(22) Filed: Jul. 21, 2025

Related U.S. Application Data
(63) Continuation-in-part of application No. PCT/US24/12475, filed on Jan. 22, 2024.
(60) Provisional application No. 63/480,723, filed on Jan. 20, 2023.

(51) Int. Cl. E04H 9/02; A62C 35/68; E04D 13/064; E04D 13/08; E04H 9/14

(52) U.S. Cl. CPC E04H 9/021; A62C 35/68; E04D 13/064; E04D 13/08; E04H 9/145

(57) ABSTRACT

A system for constructing a building capable of withstanding strong winds, earthquakes, flooding, and other natural disasters includes a top plate, a bottom plate, a foundation footing, a plurality of embedded bottom-plate hold downs, and a plurality of hold-down reinforcements. The embedded bottom-plate hold downs are perimetrically positioned around the building. The foundation footing is operatively mounted to the bottom plate by the embedded bottom-plate hold downs so that the embedded bottom-plate hold downs can be used to secure the building to the foundation footing. The top plate is operatively mounted to the bottom plate by the hold-down reinforcements so that the hold-down reinforcements can be used to secure the top plate to the bottom plate.

The current application is a continuation-in-part (CIP) application of the Patent Cooperation Treaty (PCT) application PCT/US2024/012475 filed on Jan. 22, 2024. The PCT application PCT/US2024/012475 claims a priority to the U.S. provisional patent application Ser. No. 63/480,723 filed on Jan. 20, 2023. The current application is filed on Jan. 22, 2024, while Jan. 20, 2024 was on a weekend.

### FIELD OF THE INVENTION

The present invention generally relates to a building system that is capable of withstanding strong winds, earthquakes, flooding, and other natural disasters. More specifically, the present invention is a system that secures a structure to its foundation to withstand various unforeseen forces and is relocatable.

### BACKGROUND OF THE INVENTION

Extreme weather has affected the planet since the beginning of recorded history. Hurricanes, tornadoes, earthquakes, flooding, and wildfires are a part of mankind's everyday life. Category 5 hurricanes and EF4 tornadoes are known to leave bare foundations in their wake and construction techniques in use today are not able to prevent homes and small buildings from being destroyed in winds exceeding two hundred miles per hour. Earthquakes destroy many homes and small buildings due to structural failure. Flooding and wildfires affect large areas of the country annually costing billions in damages.

An objective of the present invention is to provide users a structure that is secured to its foundation in a way that provides protection to withstand high-speed winds and seismic activity. The house/shelter is also easily relocatable in case the present invention needs to be located in another area with a lower rate of natural disasters. The embedded bottom plate hold downs located within the foundation footing around the perimeter of the structure and in footings to secure all load bearing walls. The embedded bottom plate hold down legs extend down into the foundation footing to provide additional support for the present invention structure. Thus, the present invention is a building system capable of withstanding strong winds, earthquakes, flooding, and other natural disasters due to a structurally sound support layout that integrates the structure into the underlying foundation.

### SUMMARY OF THE INVENTION

The present invention is a building system capable of withstanding hurricanes, earthquakes, flooding, and other natural disasters. The present invention seeks to provide users with a system equipped with a watering system and fireproof materials to protect the structure from wildfire damage. In order to accomplish this, the present invention comprises a foundational structure, an embedded bottom plate stud hold down connector, a plurality of wedges, an alternative embedded bottom plate hold down, an intermediate embedded bottom plate hold down, and alternative intermediate embedded bottom plate hold down, a plurality of plates, a stud hold down connector hinge connection, a hold down reinforcement with debris resistor, a rafter truss ceiling joist, a multi hold down assembly height selector, a story floor reinforcement connector single, a floor reinforcement, a rafter hold down, a hold down support bracket, a waterproof membrane, a keyway insert hold downs, a support guide, a siding material, a roofing material single guide, a roofing material vertical installation, and a watering system. Thus, the present invention is a building system capable of withstanding strong winds, earthquakes, flooding, and other natural disasters due to a structurally sound support layout that integrates the structure into the underlying foundation.

### BRIEF DESCRIPTION OF THE DRAWINGS

FIG. 1 is a perspective view of the building structural members and hold down.

FIG. 1A is a perspective sectional view of the foundation footing and the embedded bottom plate hold downs.

FIG. 2 is a sectional view from the foundation footing to the rafters and rafter hold downs.

FIG. 3 depicts a perspective view of an embedded bottom plate/stud hold down connector.

FIG. 4 depicts a perspective view of an intermediate bottom plate/stud hold down connector.

FIG. 5 depicts a perspective view of the top portion of the multi hold down assembly.

FIG. 6 depicts a perspective view of the lower portion of the multi hold down assembly.

FIG. 7 depicts a perspective view of a stud/hold down reinforcement plate.

FIG. 8 depicts a perspective view a bottom and top plate hold down wedge.

FIG. 8-1 depicts a perspective view of a rafter/truss wedge.

FIG. 9 depicts a perspective view of a stud/hold down connector hinge connection.

FIG. 10 depicts a perspective view of an alternate embedded bottom plate hold down hinge connection.

FIG. 11 depicts a perspective view of an alternate intermediate embedded bottom plate hold down hinge connection.

FIG. 12 depicts a perspective view of a multi hold down assembly.

FIG. 12A depicts a perspective view of a stud/hold down reinforcement plate.

FIG. 13 depicts a perspective view of the top portion of the multi hold down assembly.

FIG. 14 depicts a perspective view of an alternative embedded bottom plate hold down slot connection.

FIG. 15 depicts a perspective view of an alternative intermediate bottom plate hold down slot connection.

FIG. 16 depicts a perspective view of a rafter/truss ceiling joist hold down assembly.

FIG. 17 depicts a perspective view of a top plate hold down.

FIG. 17A depicts a perspective view of a rafter/truss/ceiling joint hold down.

FIG. 18 depicts a perspective view of a top plate hold down.

FIG. 18A depicts a perspective view of a stud hold down reinforcement plate.

FIG. 19 depicts a perspective view of a two-story building showing structural members and second floor reinforcement connectors single piece and structural hold downs.

FIG. 20 depicts a perspective view of a story/floor reinforcement plate.

FIG. 21 depicts a perspective view of a story/floor reinforcement connector two piece single piece reversed.

FIG. 21-1 depicts a perspective view of a two-story building showing structural members hold down support from the bottom plate to the second floor multi hold down assemblies.

FIG. 22 depicts a perspective view of a building showing hold down brackets, waterproofing, support guides siding, and roofing material.

FIG. 22-1 depicts a side view of the waterproof membrane.

FIG. 23 depicts a perspective view of a support guide front and side views.

FIG. 23-1 depicts an end of run keyway insert hold down.

FIG. 23-2 depicts a perspective view of a middle run keyway insert hold down.

FIG. 23-3 depicts a keyway insert hold down locknut.

FIG. 24 is a sectional view of an exterior wall.

FIG. 24-1 is a side view of a hold down support bracket secure nut.

FIG. 24-1A depicts a perspective view of a hold down support bracket secure nut front.

FIG. 24-1B is a perspective view of a hold down support bracket plate.

FIG. 24-1C is a perspective view of a hold down support bracket.

FIG. 24-1D is a perspective view of an X brace.

FIG. 24-2 depicts side views of support guides with debris resistors.

FIG. 25 depicts a side view of a single guide siding panel with debris resistor and mesh wire.

FIG. 25A depicts a side view of a support guide.

FIG. 25-1 depicts a side view of a double guide siding panel.

FIG. 25-2 depicts a side view of a triple guide siding panel.

FIG. 25-3 depicts a side view of a quadruple guide siding panel.

FIG. 26 depicts the roofing framing members and hold down support.

FIG. 26A depicts a double rafter hanger.

FIG. 26B depicts a double hip rafter hanger.

FIG. 26C depicts a double valley rafter.

FIG. 26D depicts a rafter cover.

FIG. 26E depicts a rafter cover.

FIG. 26F depicts a secure bolt.

FIG. 27 depicts a perspective view of a single guide roofing panel.

FIG. 27-1 depicts a perspective view of a double guide roofing panel.

FIG. 27-2 depicts a perspective view of a triple guide roofing panel.

FIG. 27-3 depicts a perspective view of a quadruple guide roofing panel.

FIG. 27-4 depicts a perspective view of a vertical installation multi guide panel.

FIG. 28 depicts a fire suppressing and watering system.

### DETAILED DESCRIPTION OF THE INVENTION

All illustrations of the drawings are for the purpose of describing selected versions of the present invention and are not intended to limit the scope of the present invention.

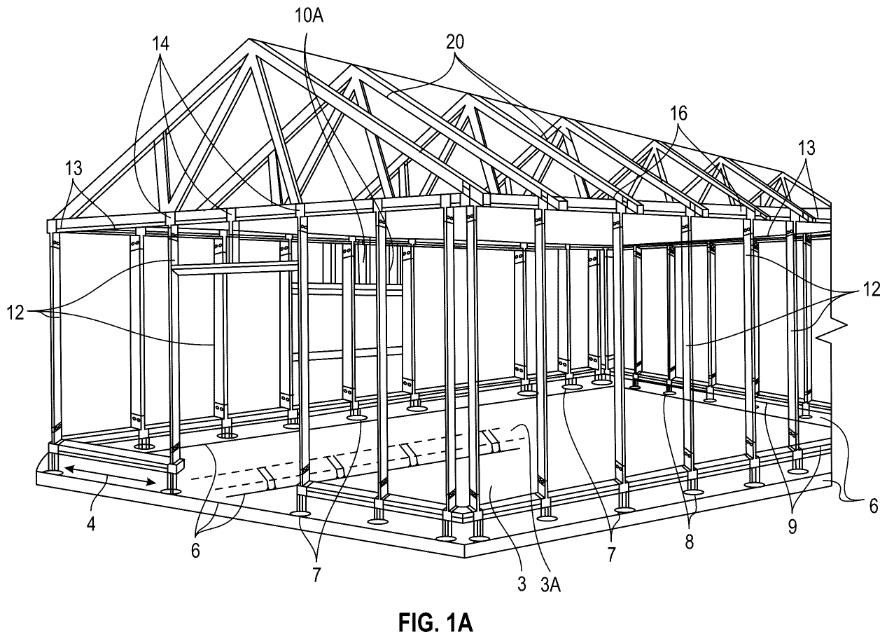

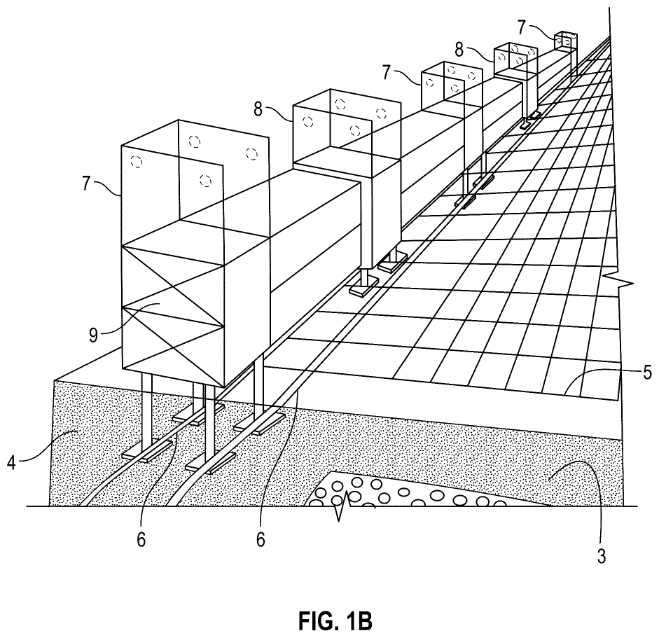

As shown in FIG. 1, the present invention is a building structure system with supportive foundation that can be easily relocated. Therefore, an object of the present invention is to secure a structure to its foundation in a way, making it capable of withstanding high-speed winds and seismic activity. Embedded bottom plate hold downs located within the foundation footing around the perimeter of the structure and in footings to secure all load bearing walls. Embedded Bottom plate hold down legs extend down into foundation footing, securing the bottom plate to the foundation footing. Intermediate bottom plate hold downs assist in securing the bottom plate to the foundation and the bottom plate to the top plate. The top plate passes through the center portion of a plurality of multi hold down assemblies. Attached vertically between the bottom plate and top plate is the stud/hold down reinforcement. The bottom of the stud/hold down reinforcement attaches to the top of the embedded and intermediate embedded bottom plate hold down, and the top of the stud/hold down attaches to the bottom of the multi hold down assembly. The upper portion of the multi hold down assembly has the rafter/truss ceiling joist seat and the rafter/truss ceiling joist are secured with the rafter/truss ceiling joist height selector hold down. Siding attaches to the framing members using hold down support brackets that attaches a support guide to the vertical framing members and the siding is installed onto the guide. Roofing materials attaches to the roofing framing members using hold down support brackets that attaches a support guide onto the roofing framing members and the roofing materials are installed onto the guide. In another object of the present invention, waterproofing membrane is installed on the siding support guide bracket threaded ends and against the framing members from the top plate to the foundation footing on the exterior wall. In another object of the present invention fire resistant materials and a watering system are used to prevent damage from wildfires. Thus, the present invention is a building system capable of withstanding strong winds, earthquakes, flooding, and other natural disasters due to a structurally sound support layout that integrates the structure into the underlying foundation.

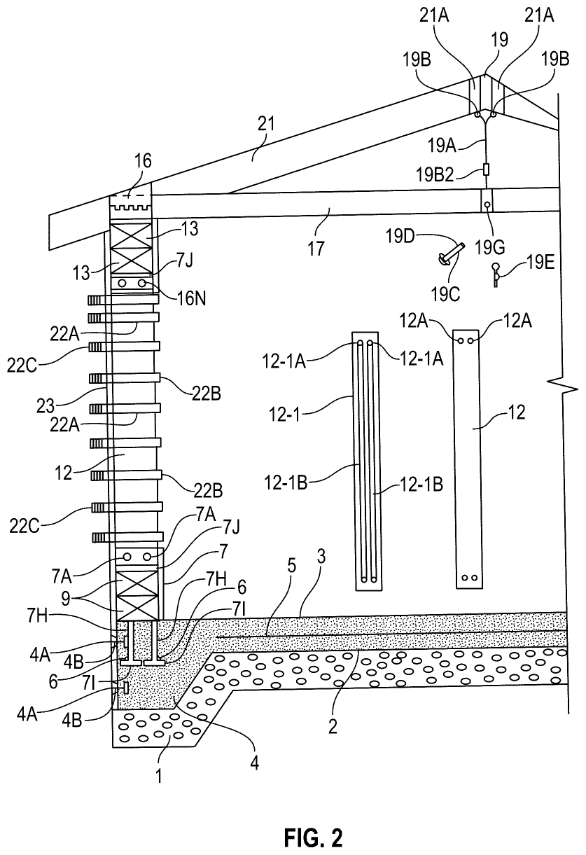

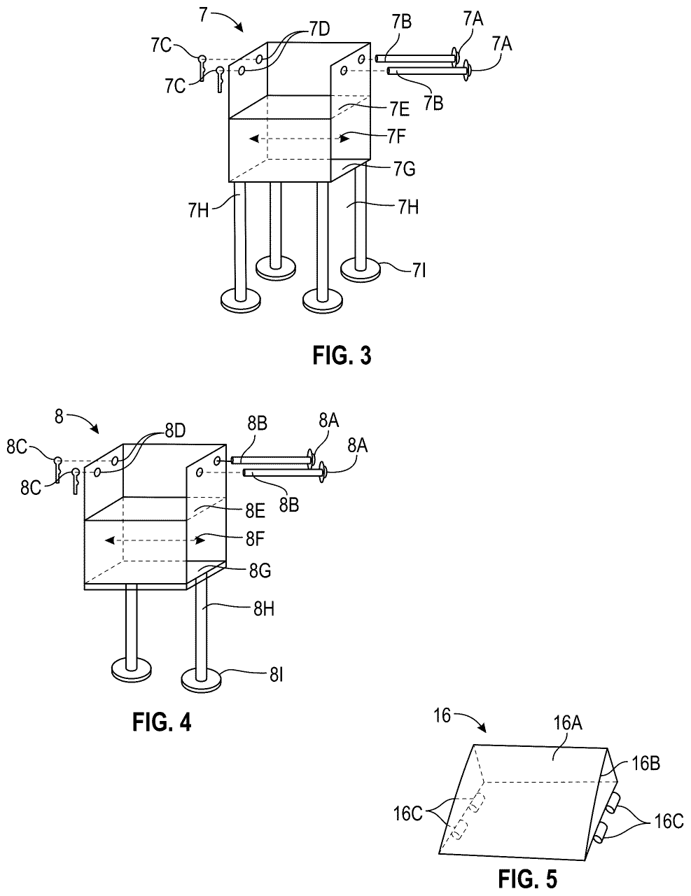

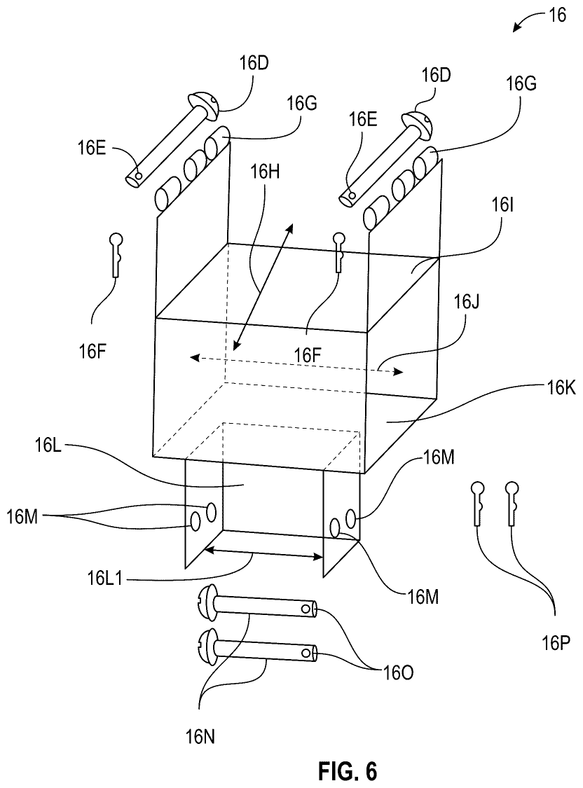

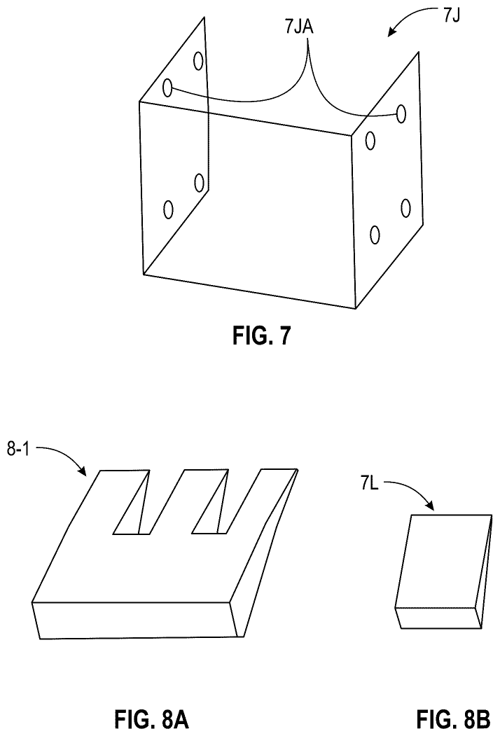

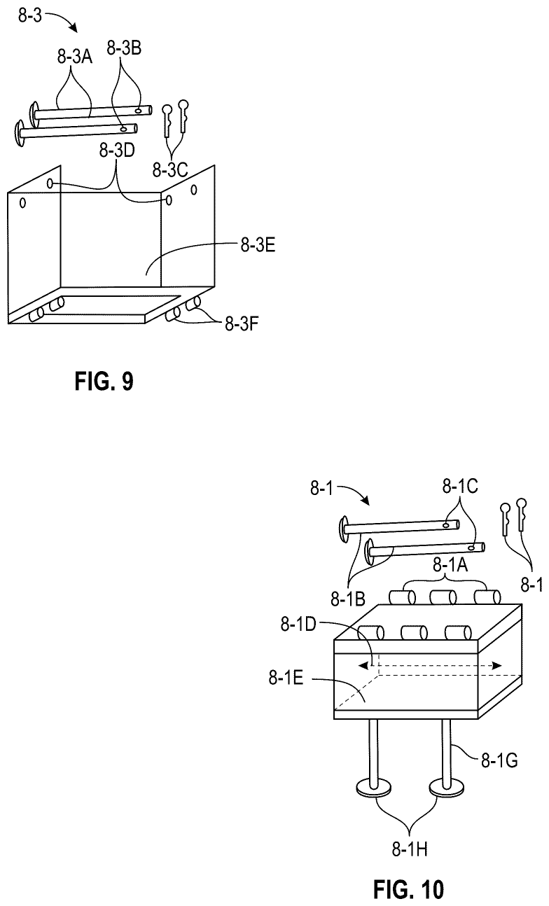

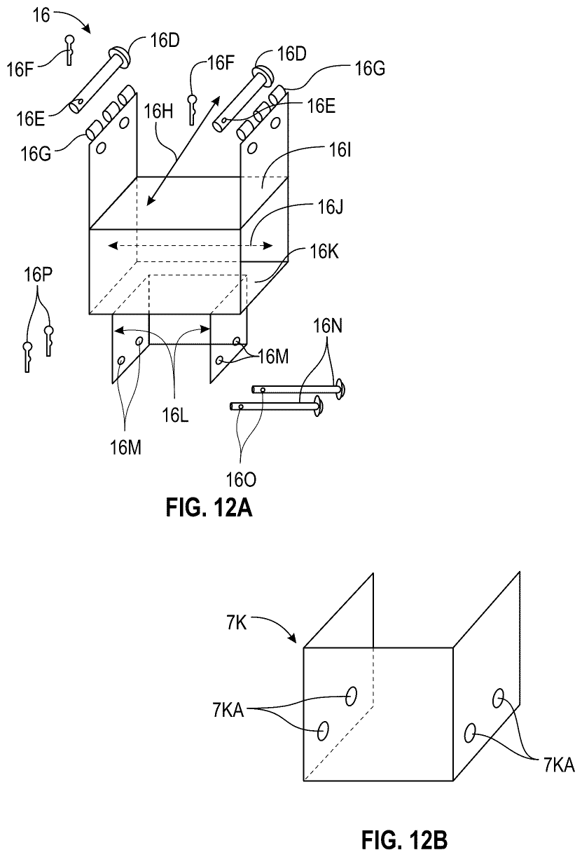

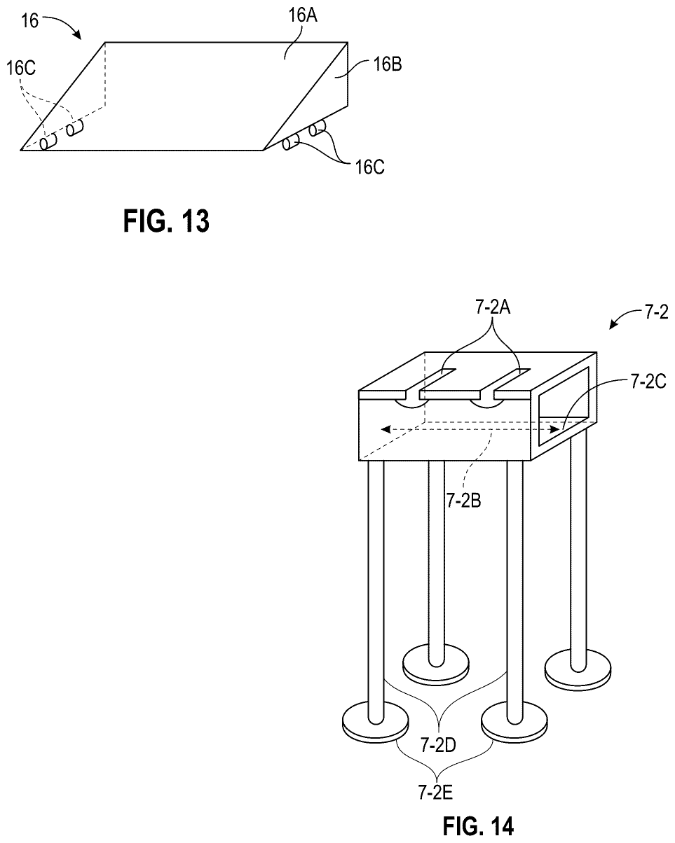

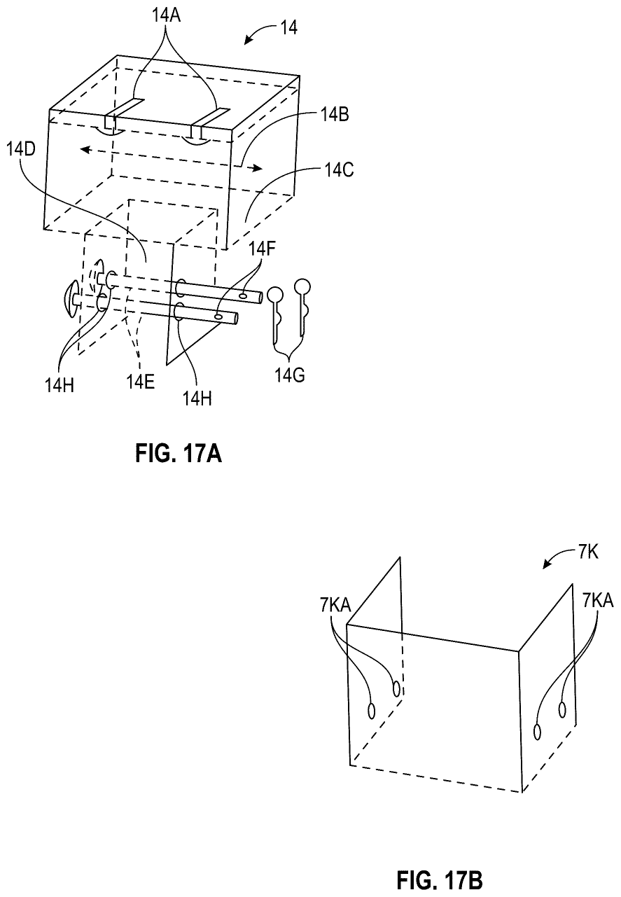

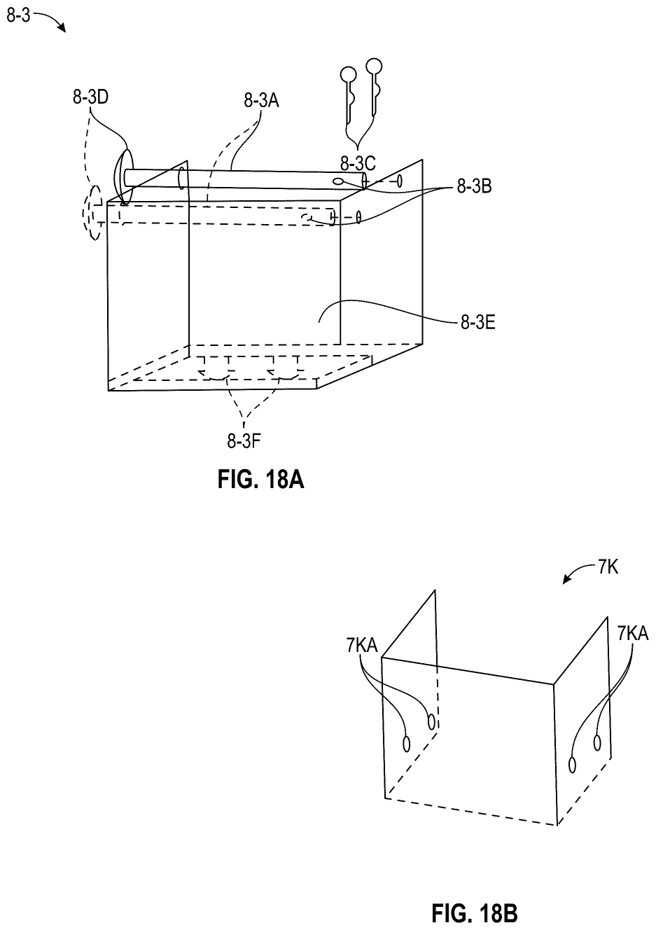

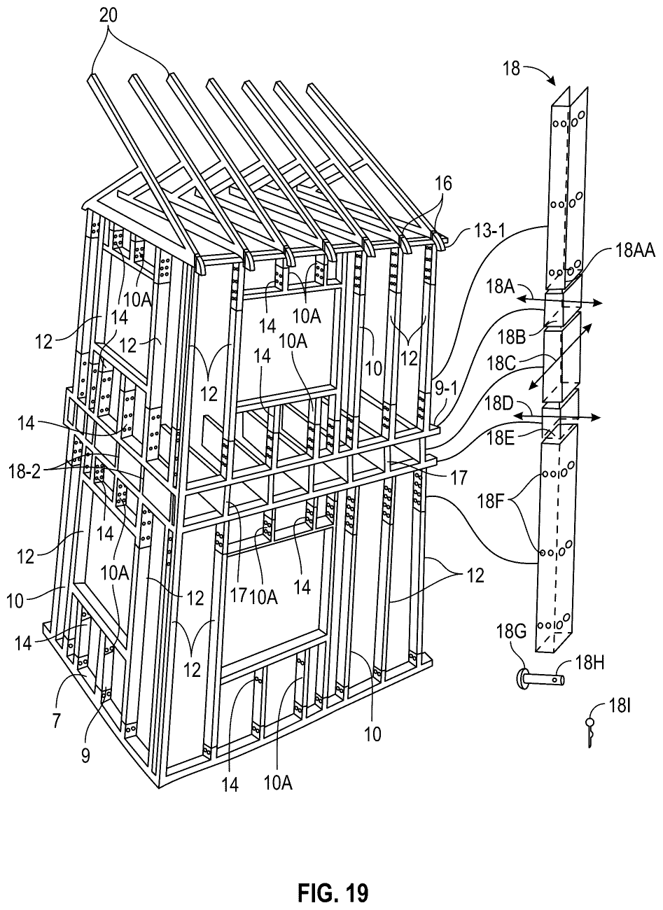

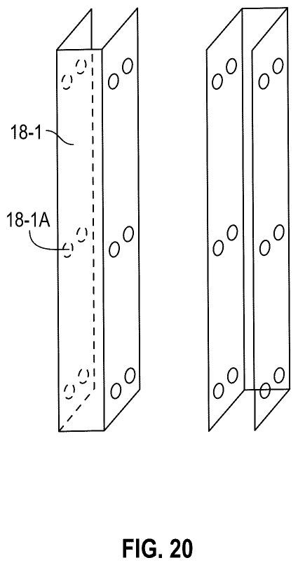

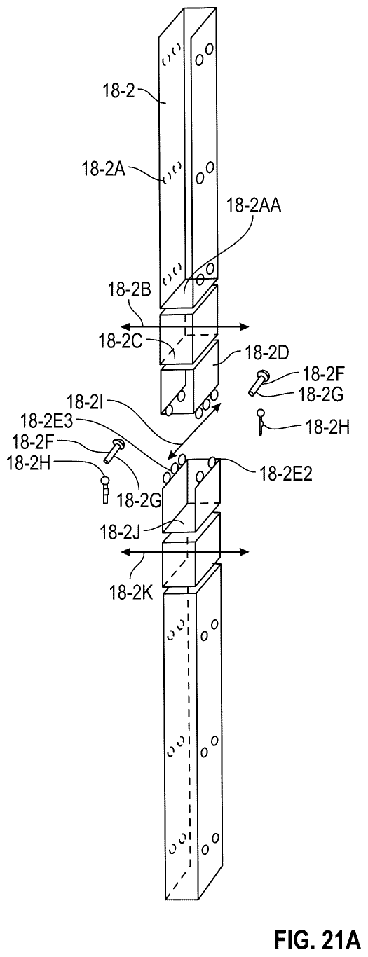

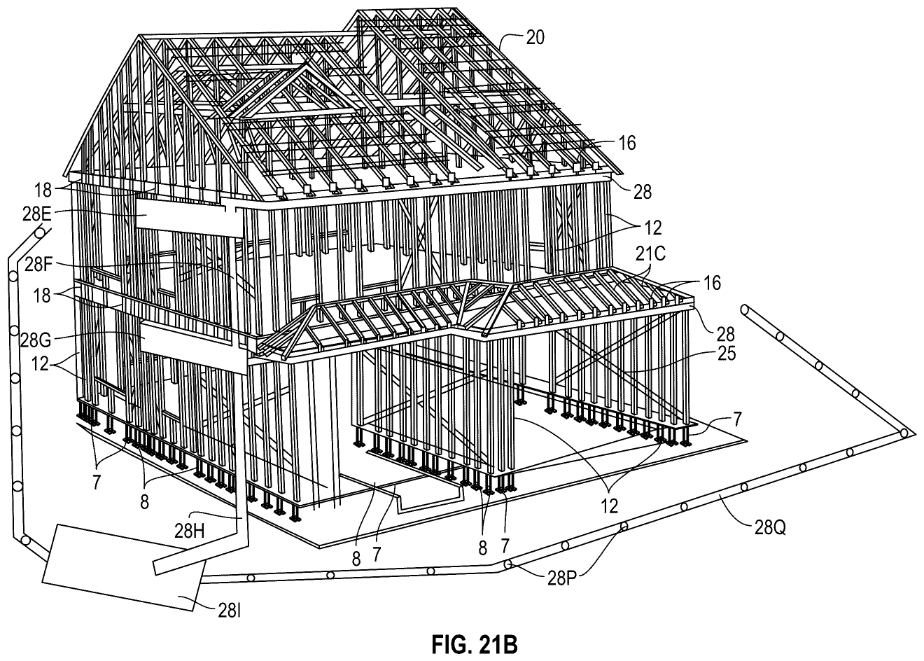

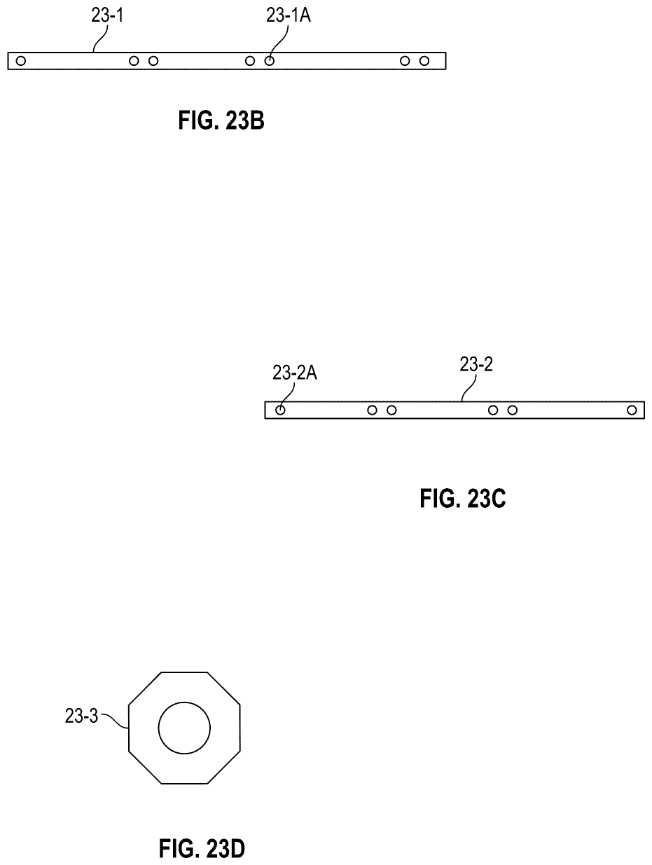

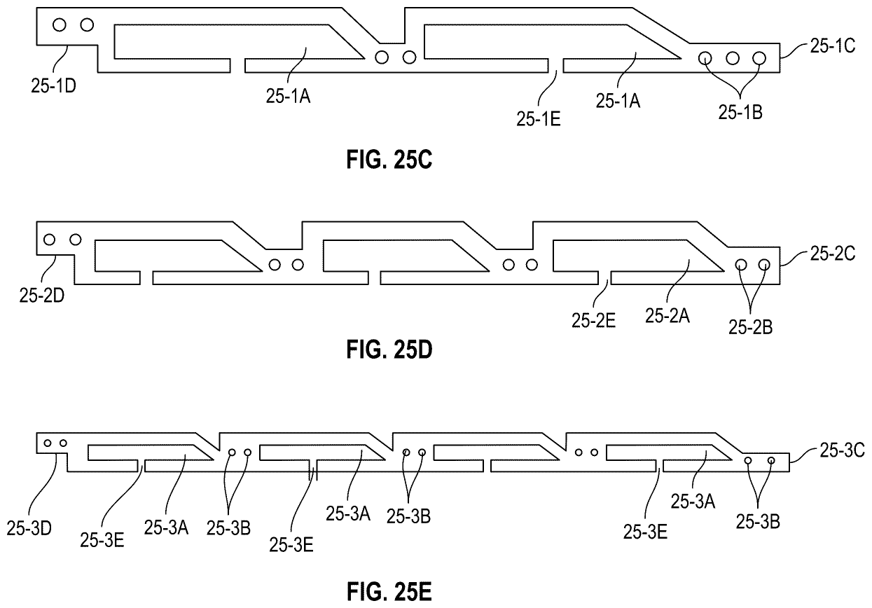

In reference to FIGS. 1-28 the primary embodiment of the invention is shown, within a foundation footing and around the structures perimeter, a plurality of embedded bottom plate hold down/stud hold down connectors 7, (EBPH/SHC), 7 preferably made of high tensile strength material such as stainless steel or iron, however it should be understood that any high tensile strength material known to those skilled in the art would suffice, attaches bottom plate 9, to foundation footing 4 as shown in FIG. 1, by passing bottom plate 9 through opening 7F in EBPH/SHC as shown in FIG. 3 and into position for installation then securing in place with wedge 71 as shown in FIG. 8 using a hammer or other striking device to tighten connection between bottom plate 9 and EBPH/SHC 7F as shown in FIG. 2 and wedge 7K is secured in place with a fastening element, a nail or screw would suffice. Alternative embedded bottom plate hold downs 7-1 and 7-2 are shown in FIGS. 10 and 14, respectfully.

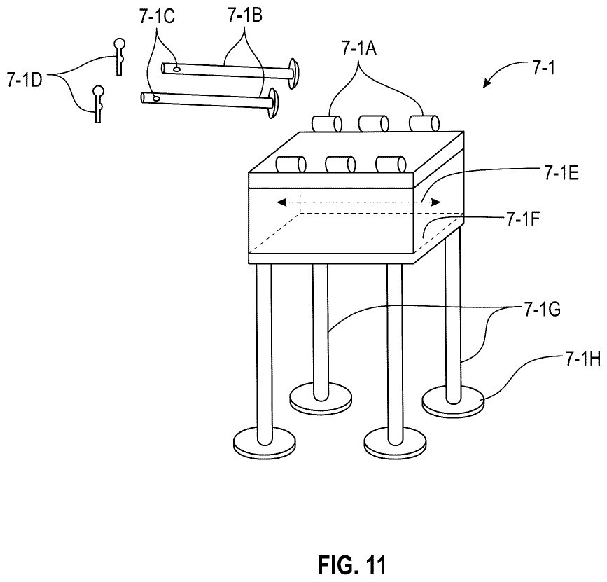

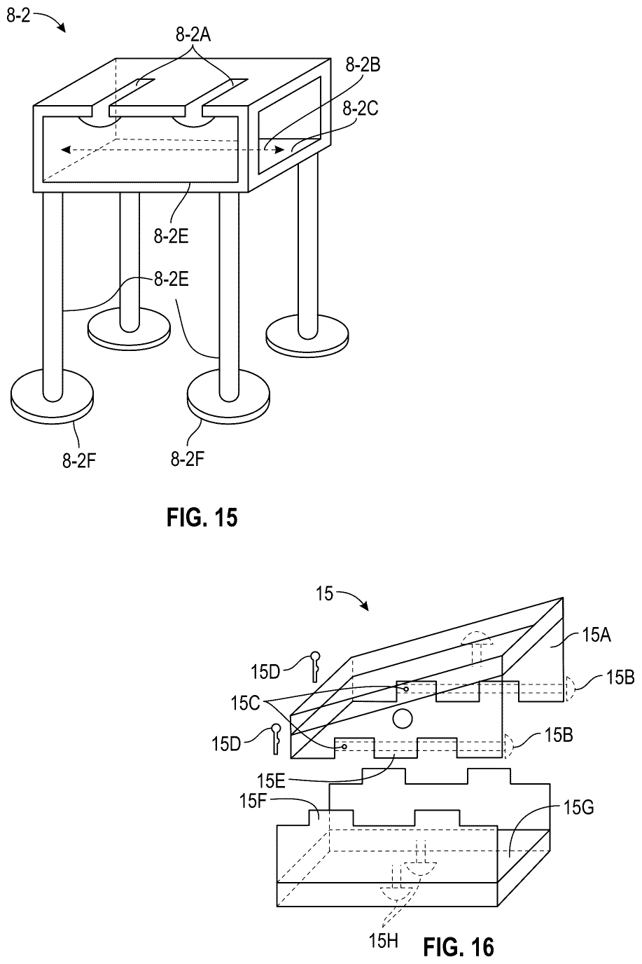

In the preferred embodiment of the invention, a plurality of intermediate embedded bottom plate hold downs stud/hold down connection 8 (EBPH/SHC) as shown in FIGS. 1, 4, and 19 preferably made of stainless steel, iron or other high strength material known to those familiar to the art. Bottom plate 9 is installed into bottom plate opening 8F in EBPH/SHC, EBPH direction 8F and secured in place by installing a wedge 7K between EBPH/SHC and bottom plate 9 then striking rear edge of wedge 7J until it is fully seated and secured in place with a fastening element, a nail or screw would suffice. Alternative intermediate embedded bottom plate hold downs 8-1 and 8-2 are shown in FIGS. 11 and 15, respectfully. Alternative intermediate bottom plate hold downs 8-1 and 8-2 are shown in FIGS. 11 and 15, respectively. intermediate bottom plate hold downs 8-1 have shorter legs 8-1G and 8-2E respectively than EBPH 7,7-1 and 7-2 respectively. Benchmarks will have to be set.

Foundation footing 4 has two continuous runs of rebar that would suffice. Tied with tie wire from one leg head 7l, to the next around the perimeter of the structure at a predetermined distance and rebar 6 is attached to leg heads 7l to secure load bearing walls 3A as shown in FIG. 1. On top of EBPH/SHC 7 sits stud/hold down connector seat 7E and on top of EBPH/SHC 8 sits the stud hold down connector seat 8E. Stud 10 and hold down reinforcement 12 are secured in place with a stud/hold down reinforcement plate 7k and EBPH/SHC bolt(s) 19H with locknut 19-H2 Both EBPH/SHC 7 and EBPH/SHC 8 have an opening to install stud 10 or hold down reinforcement 12 onto EBPH/SHC seat 7E or EBPH/SHC seat 8E.

Referring now to FIG. 2 it shows a sectional view of the structure from gravel 1 to height selector hold down 16A. Between the two are foundation footing 4, foundation keyway 4A, embedded keyway hold down bolt, welded wire fabric 5, embedded bottom plate/stud hold down connector 7, foundation slab 3, waterproofing material 23, bottom plate 9, EBPH/SHC bolt 19H, hold down reinforcement 12, multi hold down assembly 16, multi hold down assembly stud/hold down reinforcement connection bolt 16N, top plate 13, ceiling joist 17, and rafter 21.

Referring again to FIG. 1 bottom plate 9 made of one or more members can be made of wood, reinforced rubber, plastic, and other high strength materials known to those familiar to the art. In another preferred embodiment of the invention a plurality of hold down reinforcements 12 preferably made of high tensile strength steel or iron, wire rope can also be used, however any high strength material known to those skilled in the art would suffice.

Referring still to FIG. 1 hold down reinforcements 12 connects vertically between bottom plate 9 and top plate 13, 16 inches on center. The bottom of hold down reinforcement 12 connects to the top of EBPH/SHC 7 and has a hold down bolt 19H passing through one side of EBPH/SHC 7 then through hold down reinforcement bolt holes 12A then out through the opposite of EBPH/SHC 7 and secured with lock nut 19-H2. Hold down reinforcement 12 also connects to the top of EBPH/SHC 8 the same as EBPH/SHC 7.

To reduce cost, studs 10 made of rubber plastic mix, wood and other high strength low cost materials known to those familiar to the art can be used according to set benchmarks for the structure in place of hold downs 12.The top of hold downs 12/stud 10 connects to another exemplary embodiment of the invention a plurality of multi hold down assemblies 16, multi hold down assembly 16, are shown in FIGS. 1, 19, 21-1, and 22, made preferably from a high tensile strength material such as stainless steel or iron but other high strength materials known to those familiar to the art would suffice. The top of hold downs 12/stud 10 is installed into the bottom of multi hold down assembly stud/hold down connection 16L. One or more multi hold down assembly mounting bolt(s) 16N secure the top of hold downs 12 or stud 10 to multi hold down assembly 16 and top plate 13.

The center portion of each multi hold down assembly 161 is installed onto top plate framing member(s) 13, spaced 16 inches on center with multi hold down assembly stud hold down connection 16L, facing the interior of the structure sliding each multi hold down assembly 16 into its predetermined installation position and secured in place with a wedge 7K placed between top plate 13 and multi hold down assembly top plate hold down 16, using a hammer or other striking device to tighten connection. Wedge 7K is secured in place with a fastening element, a nail or screw would suffice. Hold down12/stud 10 is installed into multi hold down assembly connection 16L, one on each end of top plate 13 and one in the center. Hold down bolts 19H are installed through outer multi hold down assembly 16 then through hold down 12A/stud 10-1 and secured with locknut 19-H2. Manpower can be used to lift the wall and install the bottom of hold down12 onto embedded bottom plate/stud hold down connector seat 7E and intermediate embedded bottom plate/stud hold down connector seat 8E then raise the wall placing hold down12/stud 10 snugly against the back of connector seat 7E and 8E respectively and secured withhold down bolts 19-H, passing through one side of EBP hold down 7 or intermediate embedded bottom plate hold down 8 then through hold down12/stud 10 then through the opposite side of EBPH 7 or EBP hold down 8 and hold down locknut19-H2 secures it. Hold down12/stud 10 are installed into remaining multi hold down assembly h connection 16L and onto embedded and unembedded bottom plate hold down connectors 7E and 8E respectively and secured withhold down bolts 19H with locknut 19H2. Double top plates 13 are overlapped for strength. and the process of installing double top plate 13 with multi hold down assemblies, hr12 and studs 10 is repeated around the structure using cripple studs 10A where needed to install waterproof windows and doors.

The top portion of multi hold down assembly 16 has truss 20 or rafter 21/ceiling joist seat 161 and the two framing members truss 20 or rafter 21/ceiling joist 17 are secured with a multi hold down assembly height selector hold down 16A with multi hold down assembly hinge knuckles 16G with an odd number of hinge knuckles and multi hold down assembly height selector hold down Knuckles 1bC with an even number of hinge knuckles that are united and multi hold down assembly hinge pins 16D are used to secure the connection

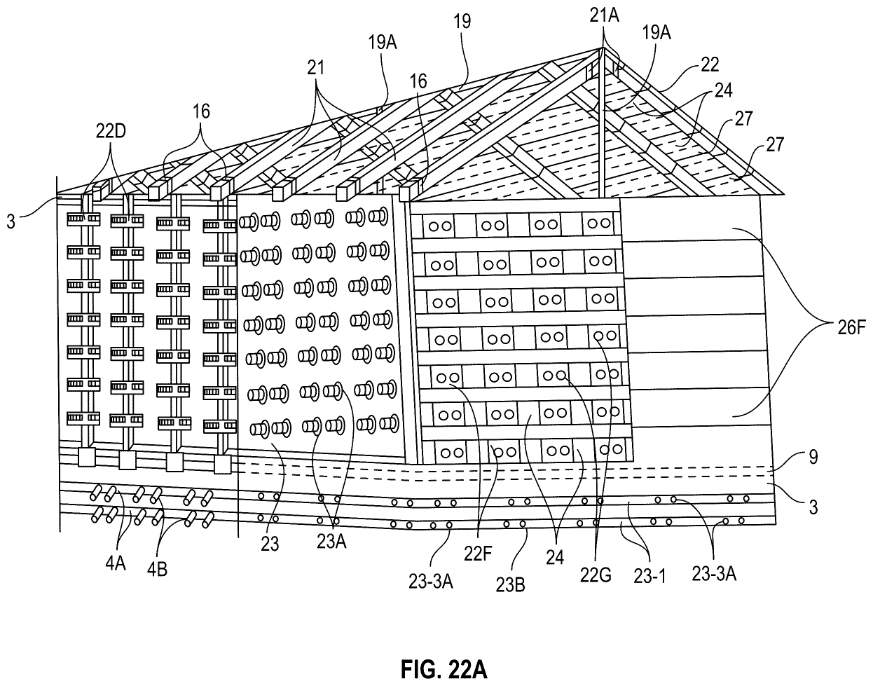

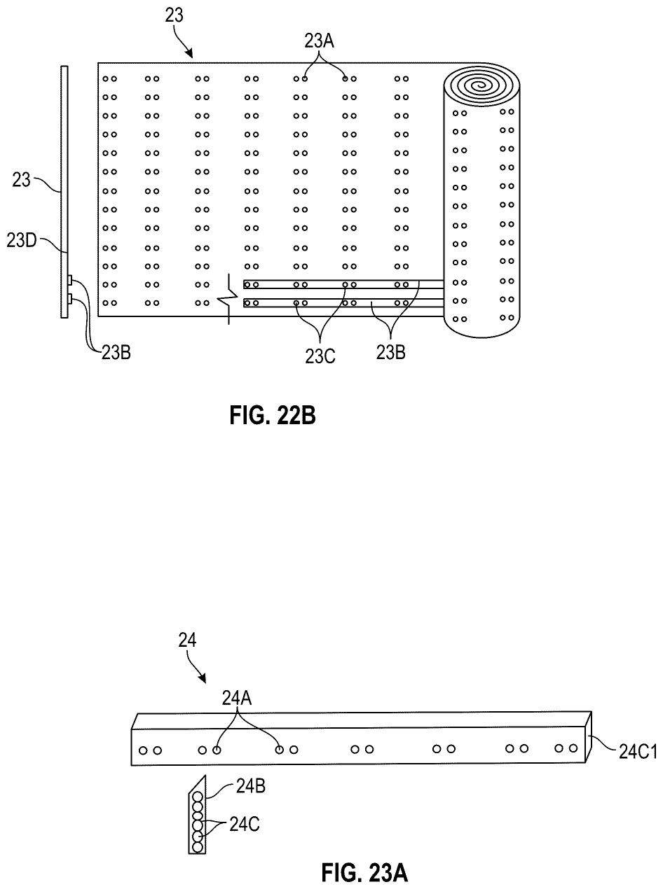

Referring now to FIG. 22, in another exemplary embodiment of the invention, a plurality of hold down support brackets 22, made of stainless steel with threaded ends 22C or stainless steel threaded ends welded onto iron or other suitable high strength material with threaded ends would suffice, are installed around hold down12/stud 10, extending out the thickness of support guide 25, the inner support bracket plate 22D and outer support bracket plate 22F. Support brackets 22 are installed by placing hold down support bracket base 22B against the interior side of the hold down 12 or stud 10 with its legs 22A in a horizontal predetermined position, inner hold down support bracket plate 22D is installed on hold down support bracket threaded ends 22C then snug against stud 10 or hold down 12 and secured in place with a hold down support bracket secure nut 22E. The rear of the hold down support bracket 22 has threaded holes for interior sheathing and bracing attachments 22H. Hold down support brackets 24 are installed onto hr12/stud 10 around the structure's perimeter.

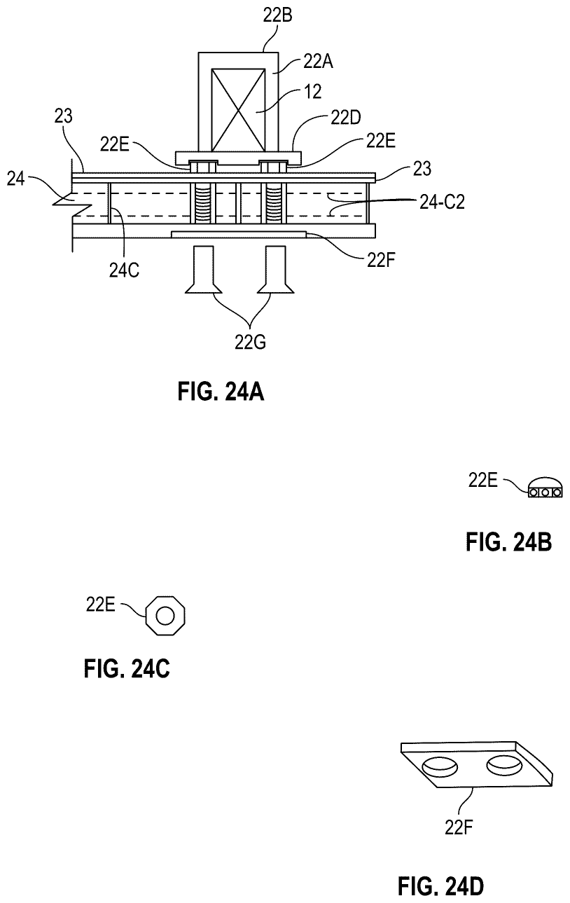

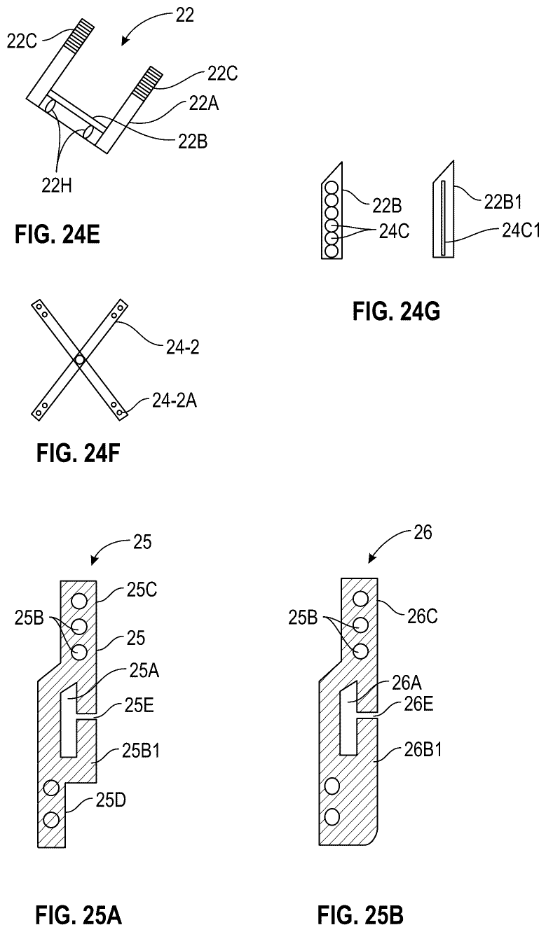

Referring now to FIG. 24, in another preferred embodiment of the invention, inner hold down support bracket plate 22D 3/16″thick and outer hold down support bracket plate, 22F ⅛″ thick with beveled holes made of stainless steel, iron or other high strength material known to those familiar to the art. Inner hold down support bracket plate 22D is installed onto hold down support bracket threaded ends 22C then snug against hold down 12 or stud 10. Beveled secure nut 22E is screwed onto support bracket threaded ends 22C until its outer end is flush with the outer face of inner hold down support bracket plate 22D and tightened to specifications and is used to support the weight of hold down support brackets 22, waterproof membrane 23, and prevent movement of the hold down support bracket 22 when installing waterproof membrane eyelets 23A onto support bracket threaded ends 22C. An outer support bracket plate 22F is installed onto support bracket threaded ends 22C then pressed snugly against support guides 25 and secured with hold downs hold down nut. In a new use, waterproof membrane 23, waterproof membrane 23, used in roofing is used for waterproofing the structure. Waterproof membrane 23 is installed onto vertical framing members hold down12/stud 10 and has waterproof membrane washer eyelets 23A, waterproof membrane, that are installed onto hold down support bracket threaded ends 22C to provide a waterproof seal around hold downs 22. Installing waterproof membrane 23, with heavy rolls 20′×100′ as shown in FIG. 22-1 weighing over six hundred pounds for two story structures with minimum seams and 10′×100′ rolls weighing 320 pounds would require a construction forklift or crane to maneuver the rolls around the structure. Smaller rolls 10′×50′ weighing 160 pounds can be installed using an all-terrain hand truck.

In another preferred embodiment of the present invention, waterproof membrane keyway Insert(s) 23B, for foundation keyway(s) 4A are located around the foundation footing 4 exterior wall, made of waterproof membrane 23 and made into the waterproof membrane 23 or waterproof membrane insert 23B is glued on or heat treated onto the waterproof membrane 23 at the bottom of waterproof membrane 23. To install, the top of waterproof membrane 23 is lapped over onto the top of top plate 13 with the top row of waterproof membrane washer eyelets 23A, waterproof membrane we 23A, positioned directly in front of the top row of hold downs support bracket threaded ends 22C, hold down support bracket threaded ends 22C, the lower rows will also align and waterproof material keyway insert bolt holes 24B are positioned directly in front of embedded keyway hold down bolts 4B and the lapped over waterproof membrane 23 is secured onto the top of top plate 13 using a nail or screw.

The top row of waterproof membrane we 23A are installed onto the hold down support bracket threaded ends 22C, waterproof membrane 23, allowed to hang down freely across the length of the wall. Waterproof membrane we 23A are installed across each successive course down to the waterproof material keyway inserts, 23B waterproof membrane, and around the structure repeating the process of installing hold down support brackets, lapping the waterproof membrane 23 across the top of top plate 13 and securing it in place with nail or screw, then installing waterproof membrane we 23A onto hold downs support bracket threaded ends 22C from one side of the structure to the other from top to bottom, wrapping around windows and doors and installing waterproof membrane 23B onto embedded keyway hold down bolts 4B then installing keyway insert hold downs 24 onto embedded keyway hold downs bolts 4B and securing with keyway insert hold down locknut

In another preferred embodiment of the invention keyway insert hold downs end run 23-1, with two bolt holes on one end and one on the opposite end. A second keyway insert hold down for field run 23-2, with one bolt hole on each end. Keyway insert hold down bolt holes 24B are installed onto embedded keyway hold down bolts 4B then pressed snugly against keyway insert hold down 24 and secure with keyway insert hold down locknuts 24C and tightened to specifications for a waterproof seal. Waterproof membrane 23 spice tape overlap is used to connect all joints. In another exemplary embodiment of the invention, support guide 24, for hurricane and tornado force winds, support guides 24, would be made with steel cable reinforcement 24C or flat steel to resist flying debris. Steel cable reinforcement stand up harness 24C, ⅜ inch to ⅝ inch would suffice, with steel mesh. Earthquake protection would require less steel support in support guide 24. for a thinner support guide 24. Flood areas would also use a thinner support guide 24 All support guides 24 are made with fire-retardant rubber and plastic mix.

In reference to FIG. 22 support guides 24 provides majority of protection for the structure's sides and roof against flying debris and should be installed 1 ½ inch apart with widths from 6″ to 12″. Support guides 24 are installed in a predetermined position onto extending hold down support bracket threaded ends 22C then pushed snugly against waterproof membrane eyelets 23A and inner hold down support bracket plate 22D. An outer hold down support bracket plate 22F is installed onto hold down support bracket threaded ends 22C and pushed snug against support guide 25. Hold down support bracket nut 22G, made of stainless steel, an extended nut with a beveled washer head, length determined by thickness of support guide 24, is installed onto hold down support bracket threaded ends 22C. When tightening, hold down support bracket nut 22G passes through outer hold down support bracket plate 22F and into support guide 24 where it's tightened to specifications. Support guides 24 are installed at a predetermined position onto extending hold down support bracket threaded ends 22C up against waterproof membrane eyelets 23A and inner hold down support bracket plate 22D around the structure ending at windows and doors and other wall openings and secured with hold down support bracket outer hold down support bracket plate 22F and hold down support bracket nut with beveled a head.

In another exemplary embodiment of the invention, siding material panels single guide 25, double guide 25-1, triple guide 25-2 and quadruple guide 25-3. The siding could also be installed vertically. All panels have the same parts with the only difference being the number of support guides mounting shapes, 25A through 25-3A, each panel made of plastic rubber mix with a fire-retardant additive and steel reinforcement are installed by sliding siding material 25 with the interior shape 25A of the external shape 25B of the support guide 25 within siding material 25A through 25-3A onto support guide 25. The rear of all siding material panels has a siding material passage 25E through 25-3E which allows siding panel to pass hold down brackets 22 during installation.

Beginning at the bottom of the structure with a starter panel of siding material 25F panels 25 through 25-3 from one end of structure sliding panels onto support guide(s) 24 to end of run ending at windows and doors and other needed openings to the end of course. When installing the second course and each course thereafter, onto the support guides 24, tongue 25C through 25-C′ and groove 25D through 25-3D joints on the upper and lower ends of all panels are aligned and distanced to allow for expansion 3/16″ would suffice. Siding materials 25 through 25-3 are installed onto each successive course of guides, from starter panel 26F on the bottom of the structure at the foundation footing 4 then up to top plate 13. Panel installation continue around the entire structure repeating the process installing siding material 25 through 25-3 onto support guides, ending at windows and doors. Exterior surfaces resemble wood, brick, jointed mortar, vinyl and more.

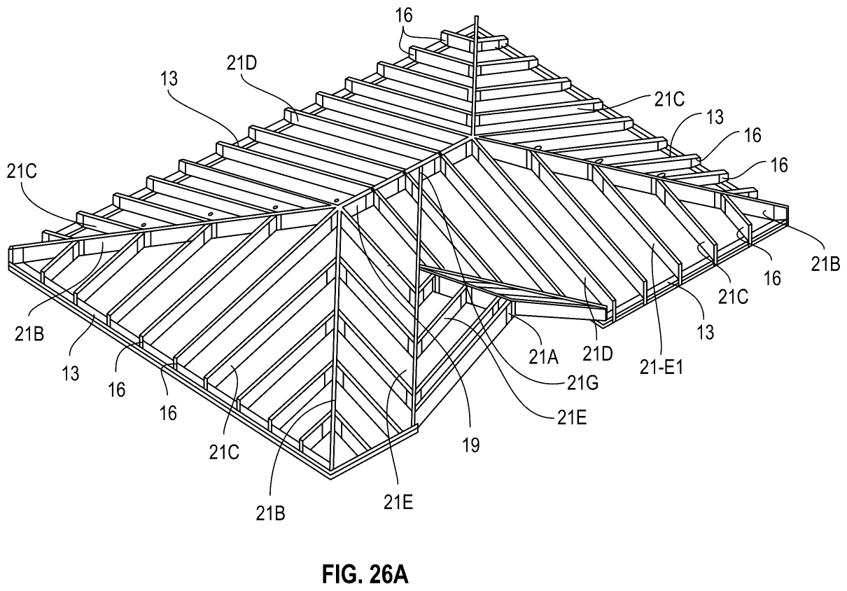

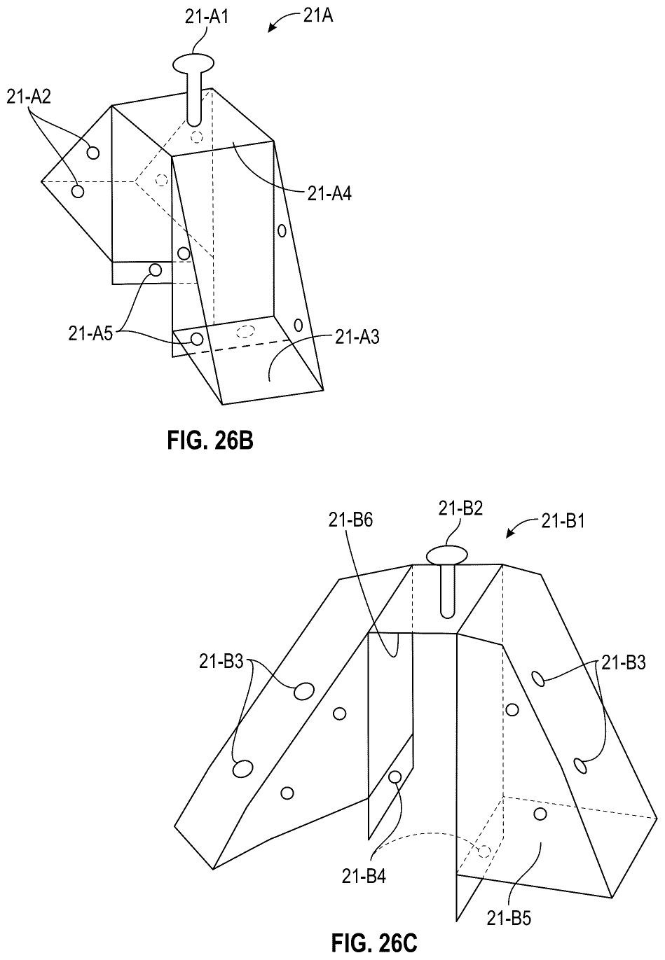

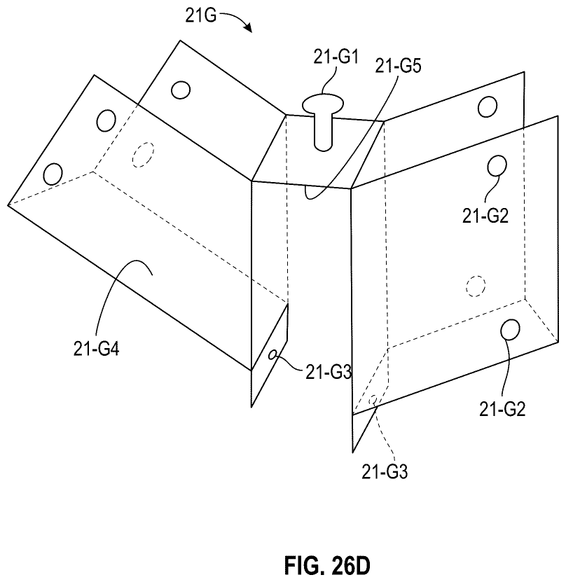

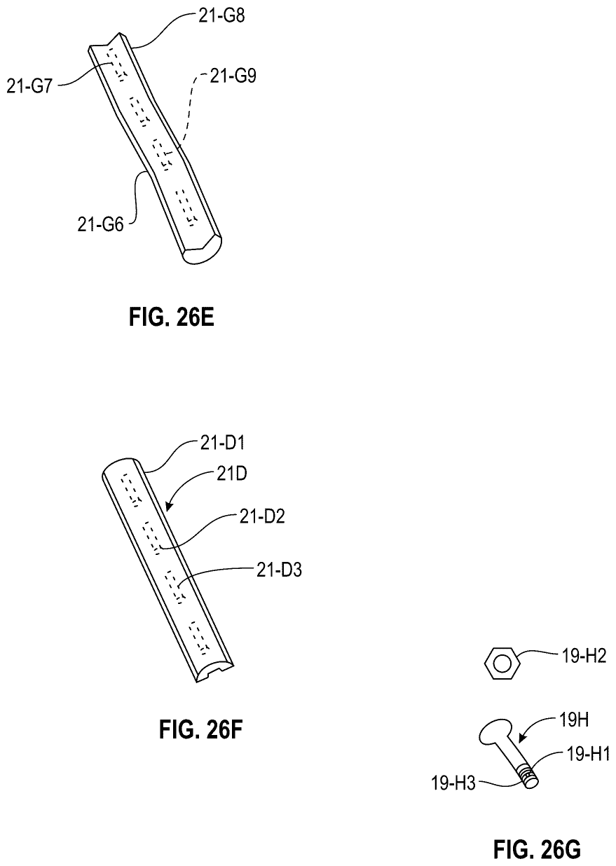

FIG. 26 depicts a roofs structural members and a method to secure them to a structure. The end of trusses 20, 19 and 21-1, and rafters 21 and 22, sits on multi hold down assembly truss/rafter ceiling joist seat 161 and is secured to top plate 13 with multi hold down assembly height selector hold down 16A and 12. The top end of rafters 21 sits in another embodiment of the invention, a double rafter hanger 21A, made of stainless steel, iron or other suitable high strength material known to those familiar to the art is installed on top of ridge board on hip rafter hanger seat 21-B6. Rafter ends are secured in double rafter hanger seat 21-B5 with one or more hold down bolts 19H passing through both hanger 21A and rafter 21 and secured with locknut 19-H2. Double rafter hangers 21A are installed 16 inches on center across the length of the ridge board 19 and rafters 21 are installed and secured on top plate 13 and ridge board 19. The top of double rafter hanger 21A has a ridge board hanger hold down cover attachment and double rafter ridge board hanger hold down attachment 21-A5 is secured to ceiling joist bolt hole 19B1 with ridge board hold down 19A and tension adjusted with hold down turnbuckle 19B2 and secured with hold down bolt 19H with locknut 19-H2. A metal strip 19A1 as shown in FIG. 22 can be used as an alternate.

In reference to FIG. 26B, in another embodiment of the invention, a double hip rafter hanger 21-B1, made of stainless steel, iron or other high strength material known to those familiar to the art, is installed onto hip rafter 21B spaced at 16 inches on center at a predetermined position. Double hip rafter hanger 21-B1 is installed. In another preferred embodiment of the invention roofing material 27-1 through 27-5 through 27E made of plastic rubber mix with a fire-retardant additive and a wire rope, stainless steel, iron or other high strength material embedded for reinforcement against flying debris. Panels 27-1 through 27-5 are installed onto the support guides 25 the same as siding material 26 onto support guides 25. Each panel 27A through 27E have the same parts with the only difference being the number of support guide mounting shapes 27A through 27E each roofing material panel has. For example, 27-1A and 27-2A both represent roofing material mounting shape.

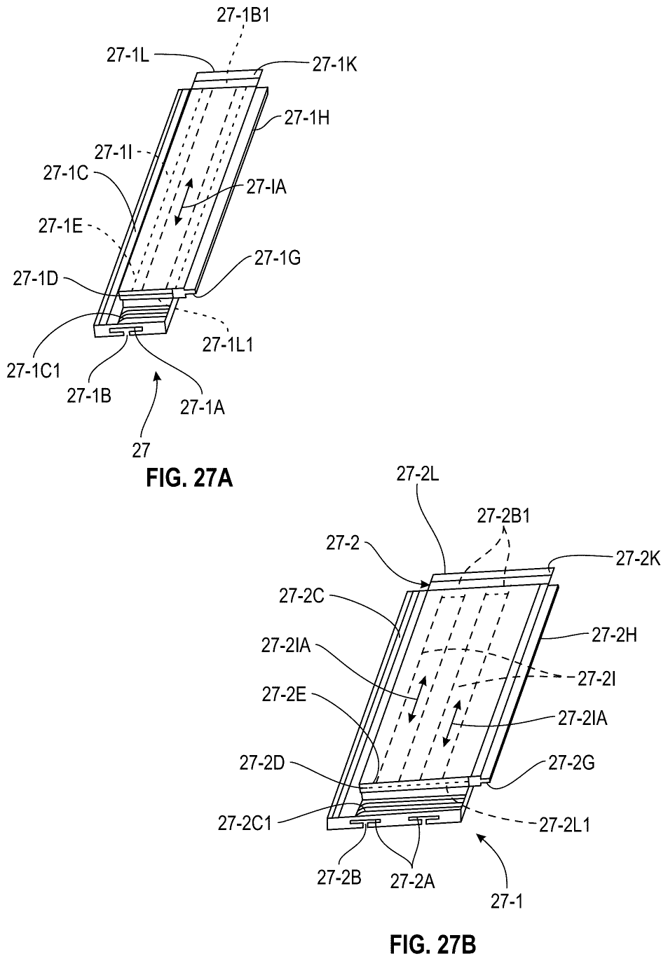

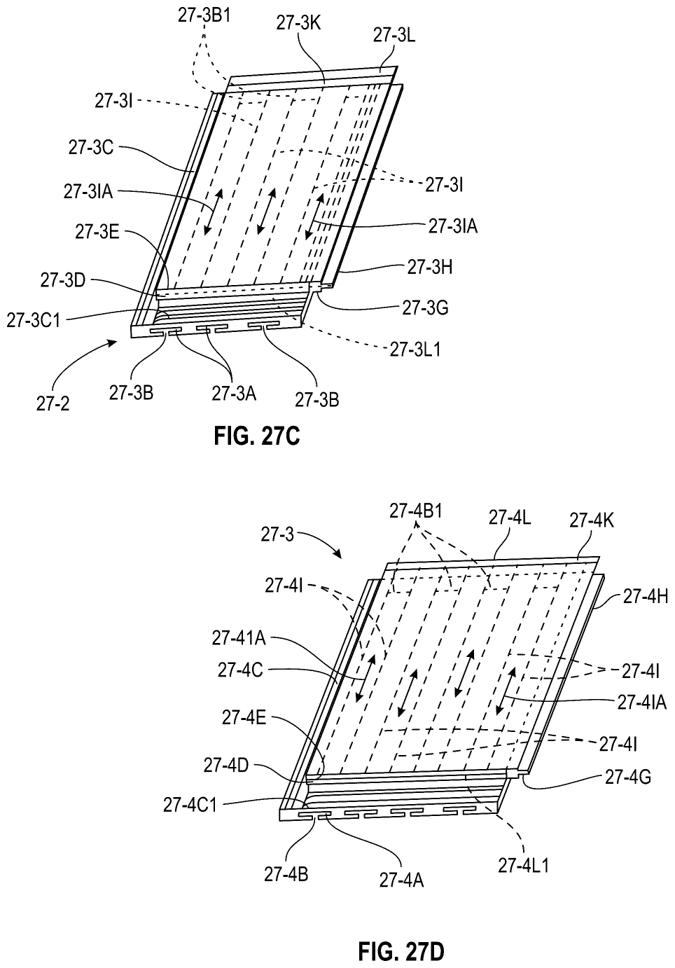

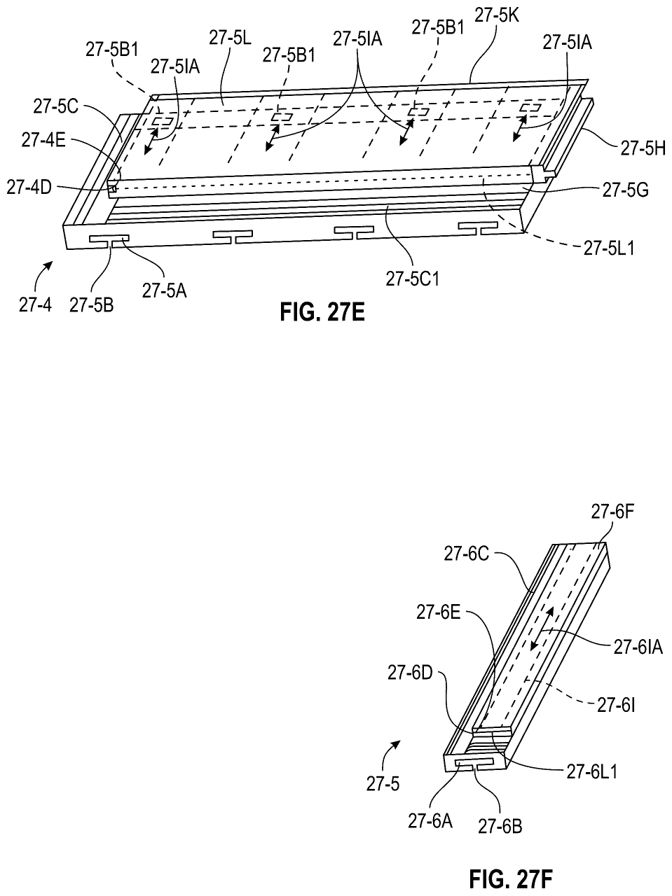

In reference to FIG. 27-5, starter panels 27-5 are installed beginning at the lower end of the roofing structural members truss 20 or rafter 21 onto the bottom course of support guides 25 installing Starter panel mounting shape 27-6A, onto support guide outer shape 24B and 24B1. As starter panel is installed onto support guides 24 tongue 27-1G through 27-5G engages seal 27-1E through 27-6E within groove 27-1D through 27-5E, applying pressure onto the seal creating a water-resistant seal. Any water passing seal 27-1E through 27-6E collects on angled horizontal drainage channel 27-1C through 27-6C and drains across to vertical drainage channel 27-1C1 through 27-6C1 down to gutters 28. Panels connect at ends with roofing panel flashing 27-1L through 27-4L inserted into roofing panel flashing seal seat 27-1L1 through 27-5L1 for a water-resistant seal. Any water passing flashing seal seat 27-1L1 through 27-5L1 drops onto vertical drainage channel 27-1C1 through 27-6C1 and down to the gutters.

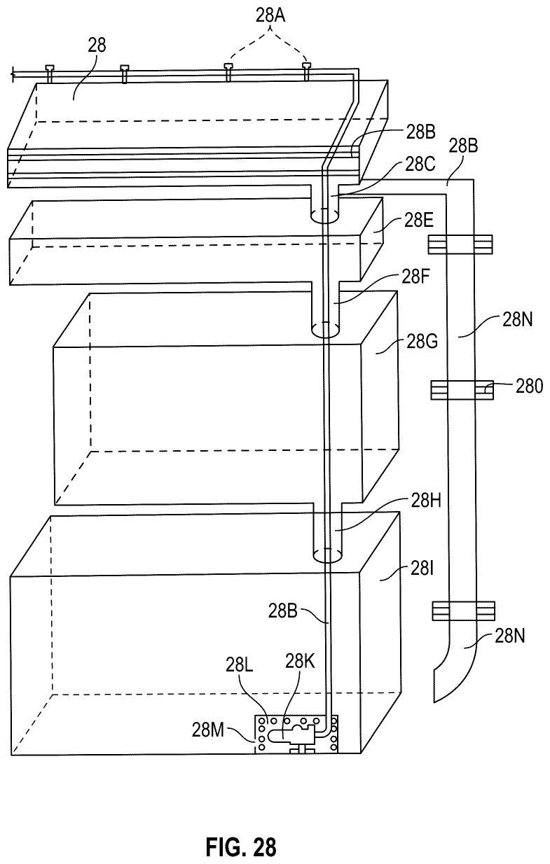

In reference to FIG. 28, the water system 28 (i.e., a gutter system) comprises a misting nozzle 28A, a slide on wall connection 28B, a upper reservoir 28E, a lower reservoir 28G, a ground reservoir 28I, a sprinkler system, and a downspout 28N. The misting nozzles are positioned at the top of the water system to spray the target areas of the present invention to dampen the entire structure to during times of a fire to ensure the surface is less likely to catch fire. The slid on wall connection allows the water system to easily be secured to the surface of the present invention. The upper reservoir further comprises a gutter to upper reservoir connecting pipe 28C, an overflow drainage pipe 28D, and an upper reservoir to lower reservoir connecting pipe 28F. The lower reservoir further comprises a lower reservoir to ground connecting pipe 28H. The sprinkler system 28A further comprises a sprinkler pipe 28J, a sprinkler pump 28K, a sprinkler pump access plate with gasket 28L, sprinkler pump access plate bolts 28M, and a plurality of pop-up sprinkler misting nozzles 28P, and a secondary sprinkler pipe 28Q. The downspout further comprises a downspout slide-on wall connection 280. The upper reservoir is connected to the lower reservoir and a ground reservoir. This allows for water to flow from the upper reservoir to the lower reservoir to the ground reservoir as needed. This allows the water to flow to the pop-up sprinklers that are fireproof and fire retardant and positioned around the house structure. The pop-up sprinklers will active during a fire storm and wet preferably the east side of the structure which is most vulnerable but can be positioned and wet all sides of the structure. The downspout is positioned to allow an overflowing reservoir to move out of the current reservoir into another reservoir.

Furthermore, the sprinkler pump is equipped with a valve system to switch between the sprinklers designed to wet the roof of the structure and the sprinklers designed to wet the surrounding area and sides of the structure.

With all the components working in tandem with each other it can be seen that, the present invention is a building system capable of withstanding strong winds, earthquakes, flooding, and other natural disasters due to a structurally sound support layout that integrates the structure into the underlying foundation.

Although the invention has been explained in relation to its preferred embodiment, it is to be understood that many other possible modifications and variations can be made without departing from the spirit and scope of the invention.

What is claimed is:

1. A system for constructing a building capable of withstanding strong winds, earthquakes, flooding, and other natural disasters comprising:
a top plate;
a bottom plate;
a foundation footing;
a plurality of embedded bottom-plate hold downs;
a plurality of hold-down reinforcements;
the plurality of embedded bottom-plate hold downs being perimetrically positioned around the building;
the foundation footing being operatively mounted to the bottom plate by the plurality of embedded bottom-plate hold downs, wherein the plurality of embedded bottom-plate hold downs is used to secure the building to the foundation footing; and
the top plate being operatively mounted to the bottom plate by the plurality of hold-down reinforcements, wherein the plurality of hold-down reinforcements is used to secure the top plate to the bottom plate.

2. The system as claimed in claim 1 further comprising:
the plurality of embedded bottom-plate hold downs comprising a plurality of legs; and
each of the plurality of legs traversing into the foundation footing.

3. The system as claimed in claim 2 further comprising:
a plurality of rebar pieces; and
the plurality of legs being operatively mounted into the foundation footing by the plurality of rebar pieces, wherein the plurality of rebar pieces is used to anchor the plurality of legs within the foundation footing.

4. The system as claimed in claim 1, wherein each of the plurality of hold-down reinforcements is made of a high-tensile strength material.

5. The system as claimed in claim 1, wherein the building is configured to withstand a wind speed exceeding 200 miles per hour (mph) and/or seismic activity.

6. The system as claimed in claim 1 further comprising:
a plurality of unembedded bottom-plate hold downs; and
the plurality of unembedded bottom-plate hold downs being configured to assist in securing a bottom end of a corresponding hold down reinforcement from the plurality of hold-down reinforcements onto the bottom plate.

7. The system as claimed in claim 6 further comprising:
the plurality of unembedded bottom-plate hold downs being perimetrically positioned around the building; and
the plurality of unembedded bottom-plate hold downs being interspersed amongst the plurality of embedded bottom-plate hold downs.

8. The system as claimed in claim 1 further comprising:
a plurality of multi hold-down assemblies;
the top plate traversing through a central portion of each of the plurality of multi hold-down assemblies; and
a top end of each of the plurality of hold-down reinforcements being operatively mounted to a lower portion of a corresponding multi hold-down assembly from the plurality of multi hold-down assemblies, wherein the plurality of multi hold-down assemblies is used to secure the top plate to the plurality of hold-down reinforcements.

9. The system as claimed in claim 8 further comprising:
a plurality of ceiling joists; and
each of the plurality of ceiling joists being operatively mounted to an upper portion of the corresponding multi hold-down assembly, wherein the plurality of multi hold-down assemblies is used to secure the plurality of ceiling joists to the top plate.

10. The system as claimed in claim 8 further comprising:
a plurality of rafters/trusses; and
each of the plurality of rafters/trusses being operatively mounted to an upper portion the corresponding multi hold-down assembly, wherein the plurality of multi hold-down assemblies is used to secure the plurality of rafters/trusses to the top plate.

11. The system as claimed in claim 1 further comprising:
a plurality of story-floor hold downs; and
the top plate and a top end of each of the plurality of hold-down reinforcements being operatively mounted to a lower portion of a corresponding story-floor hold down from the plurality of story-floor hold downs, wherein the plurality of story-floor hold downs is used to secure the top plate to the plurality of hold-down reinforcements.

12. The system as claimed in claim 11 further comprising:
a plurality of ceiling joists; and
each of the plurality of ceiling joists being operatively mounted to a central portion of the corresponding story-floor hold down, wherein the plurality of story-floor hold downs is used to secure the plurality of ceiling joists to the top plate.

13. The system as claimed in claim 11 further comprising:
a story-floor top plate;
a story-floor bottom plate;
a plurality of story-floor hold-down reinforcements;
the plurality of story-floor hold-down reinforcements being perimetrically positioned around the building;
the story-floor top plate being operatively mounted to the story-floor bottom plate by the plurality of story-floor hold-down reinforcements, wherein the plurality of story-floor hold-down reinforcements is used to secure the story-floor top plate to the story-floor bottom plate; and
each of the plurality of story-floor hold-down reinforcements being operatively mounted to an upper portion of the corresponding story-floor hold down, wherein the plurality of story-floor hold downs is used to secure the plurality of story-floor hold-down reinforcements to the top plate.

14. The system as claimed in claim 1 further comprising:
a plurality of hold-down support brackets;
a plurality of support guides;
a plurality of siding pieces;
the plurality of support guides being operatively mounted to the plurality of hold-down reinforcements by the plurality of hold-down support brackets, wherein the plurality of hold-down support brackets is used to secure the plurality of support guides to the plurality of hold-down reinforcements; and
the plurality of siding pieces being operatively mounted into the plurality of support guides, wherein the plurality of hold-down support guides is used to arrange the plurality of siding pieces into a laterally-enclosing structure.

15. The system as claimed in claim 1 further comprising:
a waterproof membrane; and
the waterproof membrane being configured to prevent water damage to a lateral portion of the building and/or a roofing portion of the building.

16. The system as claimed in claim 1 further comprising:
a fire-retardant material; and
the fire-retardant material being configured to prevent fire damage to a lateral portion of the building and/or a roofing portion of the building.

17. The system as claimed in claim 1 further comprising:
a gutter system;
the gutter system comprising an upper reservoir, a lower reservoir, and a ground reservoir;
the upper reservoir being operatively mounted to a roofing portion of the building, wherein the upper reservoir is used to collect rainwater;
the upper reservoir being in fluid communication with the lower reservoir;
the lower reservoir being gravitationally lower than the upper reservoir;
the lower reservoir being in fluid communication with the ground reservoir; and
the ground reservoir being gravitationally lower than the lower reservoir.

18. The system as claimed in claim 17 further comprising:
the gutter system further comprising a downspout; and
the downspout being operatively mounted to a lateral portion of the building, wherein the downspout is used to relieve the gutter system of excess rainwater.

19. The system as claimed in claim 17 further comprising:
a sprinkler system;
the ground reservoir being in fluid communication with the sprinkler system; and
the sprinkler system being configured to release rainwater throughout the building in order to put out a fire within the building.
